(19) United States
(12) Patent Application Publication
(10) Pub. No.: US 2024/0067329 A1
(43) Pub. Date: Feb. 29, 2024

(54) FLYING OBJECT CONTROL METHOD

(71) Applicant: AERONEXT INC., Tokyo (JP)

(72) Inventor: Yoichi SUZUKI, Tokyo (JP)

(21) Appl. No.: 18/259,658

(22) PCT Filed: Jan. 1, 2020
(86) PCT No.: PCT/JP2021/000001

§ 371 Date: Jun. 28, 2023

(51) Int. Cl. B64C 13/18; B64C 39/02

(52) U.S. Cl. CPC B64C 13/18; B64C 39/024

(57) ABSTRACT

Provided is a method for controlling the directional orientation of a flying object so that the flying object faces in a direction that increases the efficiency of flight over the immediately preceding state based on predetermined information. To provide a method of flight control whereby a flying object having directional characteristics according to such a configuration can fly in an attitude suitable for the relative wind direction and wind speed in flight in order to actively utilize lift, reduce drag, and the like. According to such a configuration, the optimal flight attitude can be obtained by adjusting the wind direction and aircraft direction, thereby increasing safety while improving fuel efficiency.

### TECHNICAL FIELD

This invention relates to a method of controlled flight of a flying object.

### BACKGROUND ART

In recent years, research and demonstration tests have been conducted toward the practical application of services using flying objects such as drones and unmanned aerial vehicles (UAVs; hereinafter collectively referred to as “flying objects”). Flying objects equipped with multiple fixed pitch propellers and tilting their bodies to move (hereinafter collectively referred to as “multicopters”) do not require a takeoff/landing runway, as is the case with fixed-wing aircraft, and can therefore be operated in relatively small areas, making them suitable for delivery and rescue operations.

However, the airframe shape of a multicopter is less fuel-efficient than that of a general fixed-wing aircraft, etc., which flies using the lift generated by its main wings, and also does not take into account the drag force generated by the body part. In view of this situation, Patent Literature 1 discloses a flying object that reduces the load on the rotor blades. (See, for example, Patent Literature 1).

### PRIOR ART LIST

### Patent Literature

[Patent Literature 1] US20200001995A1

### SUMMARY OF THE INVENTION

### Technical Problem

In Patent Literature 1, the angle between the axis of rotation of the rotary wing and the normal of the reference plane of the body part is set between 5 and 30 degrees to form a positive angle of attack when the rotary wing aircraft of the invention moves forward, and the lift generated by the body part reduces the load on the rotary wing to improve the time available for flight (hereinafter collectively called “conventional aircraft) has been developed.

Multicopters constantly consume energy while remaining in the air. Conventional aircraft reduce energy consumption and improve the time available for flight. This effect is achieved when a directional flying object flies at an appropriate angle facing the wind. However, since a multicopter can fly without always flying directly into the wind as a fixed-wing aircraft does, it can fly at an angle that is inefficient and ineffective or, energy consumption may increase.

When flying outdoors, the flying object is subject to wind from various directions in addition to the wind it receives as it moves forward. For example, it is obvious that the flying object should point its nose in different directions when there is no wind and when it receives a strong crosswind, even if it is traveling in the same direction at the same speed.

Therefore, one object of this invention is to provide a flight control method that enables flying objects with directional characteristics to fly in a suitable attitude with respect to the relative wind speed in flight in order to actively utilize lift, reduce drag, and other effects.

### Technical Solution

According to the invention, it is possible to provide a method of controlling a flying object, which controls the direction of the flying object so that it faces in a direction that increases the efficiency of flight over the immediately preceding state, based on predetermined information.

### Advantageous Effects

According to the invention, a flying method that improves the flying efficiency of flying objects can be provided.

### BRIEF DESCRIPTION OF THE DRAWINGS

FIG. 1 shows a conceptual diagram of the flying object according to the invention in cruising mode, viewed from the side.

FIG. 2: shows a functional block diagram of the flying object of FIG. 1.

FIG. 3 shows a side view of the flying object of FIG. 1 when hovering.

FIG. 4 shows a top view of the flying object shown in FIG. 1 when hovering.

FIG. 5 shows a general wing shape.

FIG. 6 shows the lift characteristics of the airfoil shown in FIG. 5.

FIG. 7 shows the drag characteristics of the airfoil shown in FIG. 5.

FIG. 8 shows a side view of an example of the configuration of the flying object according to the invention in cruise flight.

FIG. 9 shows a side view of the flying object of FIG. 8 when hovering.

FIG. 10 shows a top view of the flying object of FIG. 8 when hovering.

FIG. 11 shows a schematic diagram of the shape of the flying object of FIG. 8.

FIG. 12 shows a graph of the lift characteristics of the shape shown in FIG. 11.

FIG. 13 shows a graph showing the drag characteristics of the shape of FIG. 11.

FIG. 14 shows a side view of an example of the configuration of the flying object according to the invention in cruise.

FIG. 15 shows a side view of the flying object of FIG. 14 in hovering.

FIG. 16 shows a side view of a conventional aircraft in cruise.

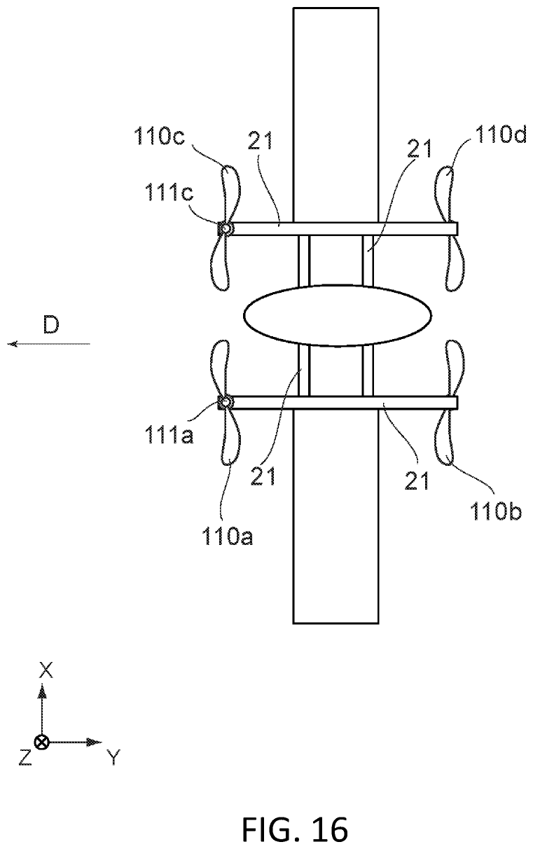

FIG. 17 shows a side view of the conventional aircraft in cruise.

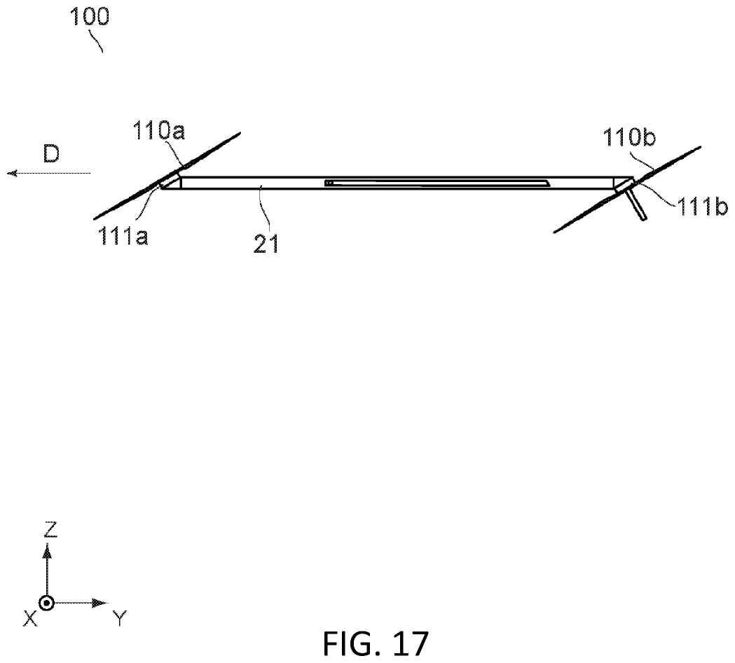

FIG. 18 shows a side view of the aircraft shown in FIG. 17 hovering.

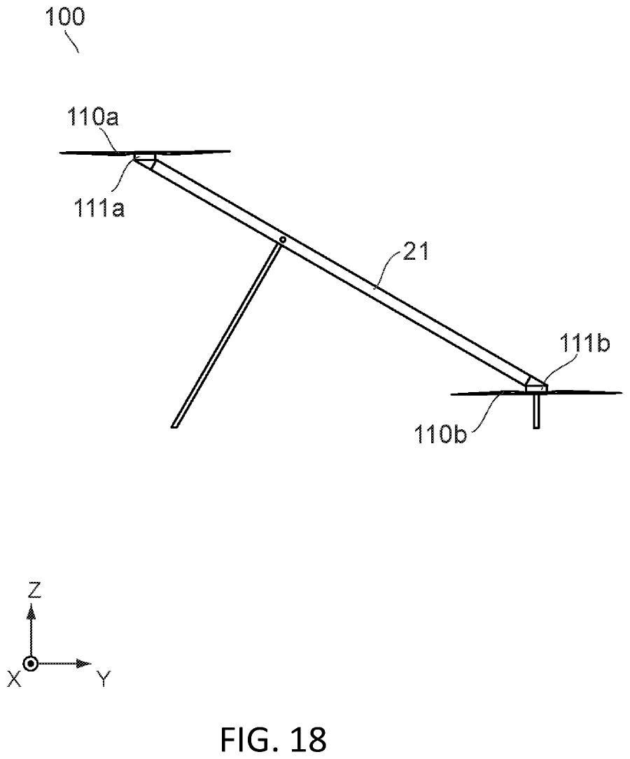

FIG. 19 shows a top view of a conventional aircraft hovering.

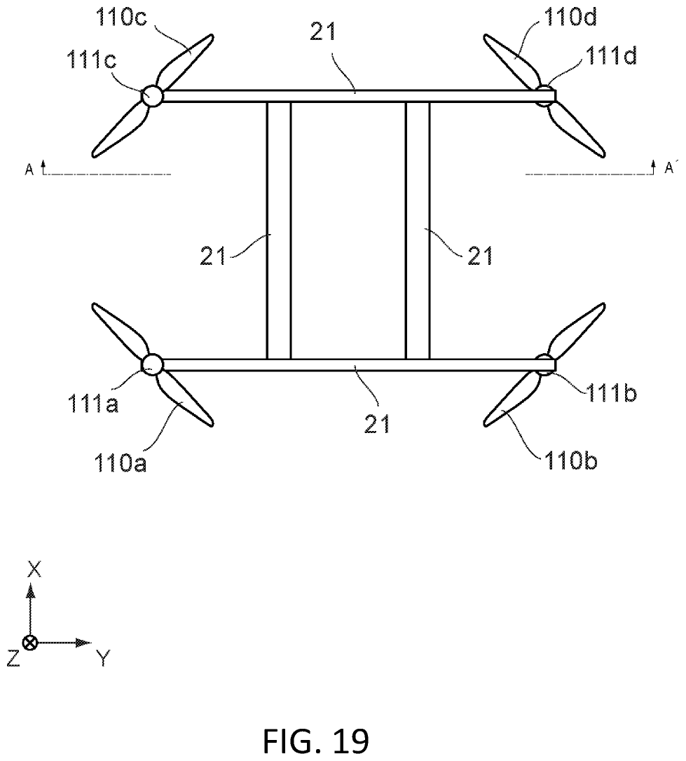

FIG. 20 shows a side view of the aircraft shown in FIG. 19 hovering.

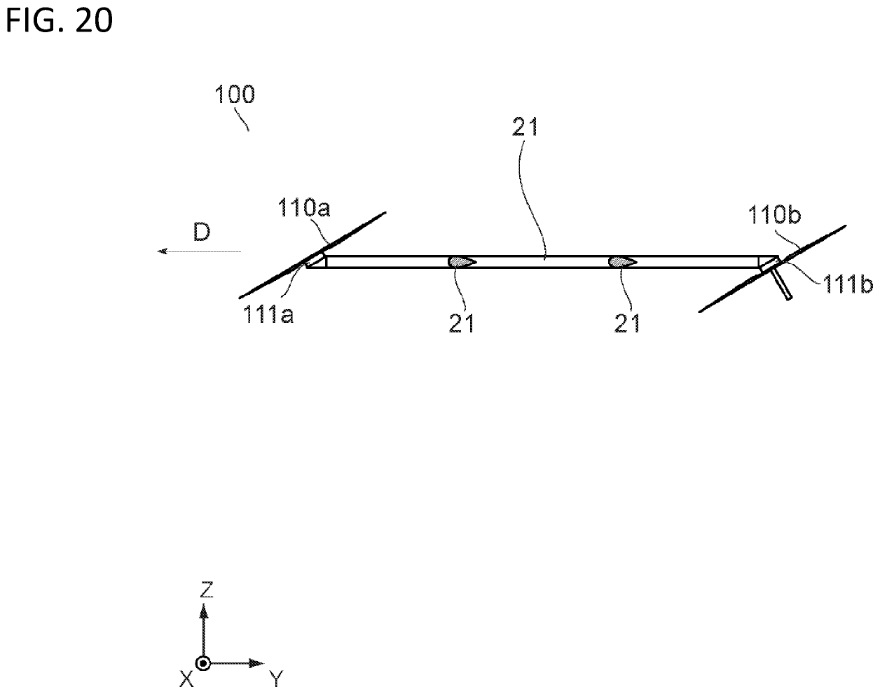

FIG. 21 shows a top view of a conventional aircraft hovering.

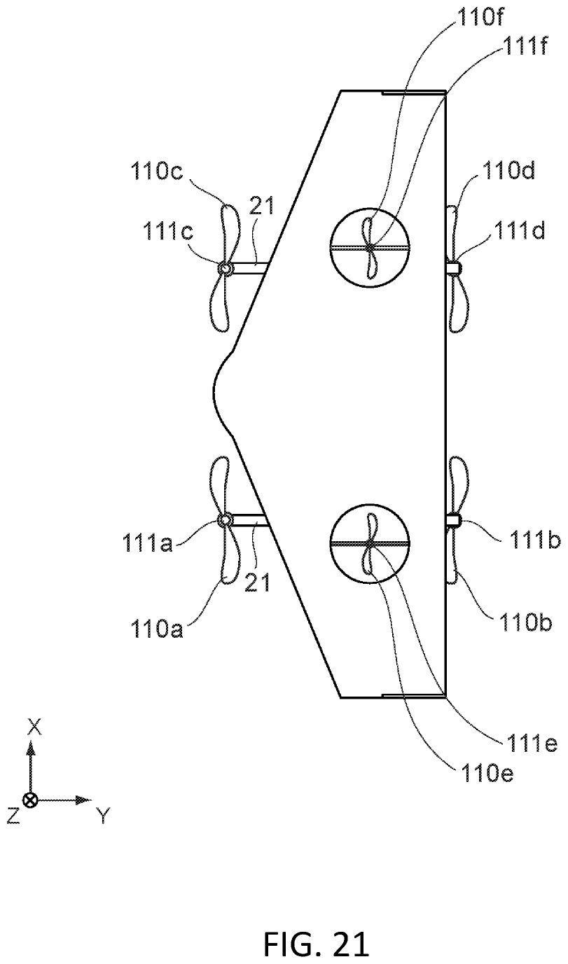

### DETAILED DESCRIPTION OF THE EMBODIMENTS

The following is a list and description of the contents of this embodiment of the invention. The flying object's flying method according to this embodiment of the invention consists of the following:

[Item 1]

A method for controlling a flying object, wherein the direction of an airframe of the flying object is controlled so that it faces in a direction that increases the efficiency of flight over the flying object's immediately preceding state, based on predetermined information.

[Item 2]

The method of controlling a flying object as described in item 1,
wherein the flying object is flying in a direction of travel; and
the flying object's airframe direction is controlled regardless of the direction of travel.

[Item 3]

The method for controlling a flying object as described in either claim 1 or claim 2,
wherein the direction that improves flight efficiency is increased is a predetermined set direction with respect to the flying object's airframe; and
wherein the method controls the flying object's airframe direction to be the same as the set direction.

[Item 4]

The method of controlling a flying object according to item 3,
wherein the set direction is a direction in which flight efficiency is maximized when the flying object is subjected to wind from a predetermined direction.

[Item 5]

The method of controlling a flying object according to item 4,
wherein the set direction is the direction in which flight efficiency is maximized when the front of the flying object's airframe is facing the wind.

[Item 6]

The method of controlling a flying object according to item 1,
wherein the flying object's airframe direction is controlled based on information on the wind affecting the flying object.

[Item 7]

The method of controlling a flying object according to item 6, further comprising:
acquiring a relative wind direction relative to the flying object; and
controlling the flying object's airframe direction based on the acquired relative wind direction.

[Item 8]

The method of controlling a flying object according to item 6, further comprising:
acquiring a relative wind direction and a relative wind speed relative to the flying object; and
controlling the flying object's airframe direction based on the acquired relative wind speed and relative wind direction.

[Item 9]

The method of controlling a flying object according to item 5,
wherein the wind information affecting the flying object is information calculated based on both the speed of the flying object in the direction of travel and at least one of the wind direction or wind speed around the flying object.

[Item 10]

The method of controlling a flying object as in any one of items 5 to 8,
wherein the flying object comprises an anemoscope; and
wherein the flying object's airframe direction is controlled according to the wind direction obtained from the anemoscope.

[Item 11]

The method for controlling a flying object as in any one of items 5 to 9, further comprises:
controlling the flying object's airframe direction based on the wind information that affects the flying object by referencing an external wind direction information database.

[Item 12]

The method of controlling a flying object according to item 1,
wherein the flying object controls the direction of the flying object's airframe so that the resistance of the wind against the flying object is reduced when the flying object is hovering.

[Item 13]

The method of controlling a flying object according to item 1,
wherein the flying object controls the direction of the airframe so that the wind resistance against the airframe is reduced when the flying object is ascending or descending.

[Item 14]

A method of controlling a flying object having a shape asymmetrical in a forward/backward direction and a left/right direction,
wherein the flying object is controlled so that the direction of the flying object is different from the front-back direction.

[Item 15]

A method of controlling a flying object flying in a direction of travel, comprising:
obtaining a relative wind direction to the flying object; and
controlling the flying object to change the nose direction of the flying object based on the relative wind direction.

[Item 16]

A flying object comprising:
a flight control part that flies the flying object in the forward direction;
a sensor part that acquires predetermined information that affects the flight;
a calculation part that, regardless of the forward direction, calculates the direction that improves flight efficiency over the flying object's immediately preceding state based on the predetermined information; and
a flying object's airframe direction control unit that controls the flying object's airframe direction based on the results of the calculation.

[Item 17]

A flight control program, which causes a flight part of a flying object to function as:
flight control means for flying in the direction of travel;
sensor means for acquiring predetermined information affecting the flight;
calculation means for calculating a direction in which the flying efficiency is higher than in the flying object's immediately preceding state based on the predetermined information, regardless of the direction of travel; and
flying object's airframe direction control means for controlling the flying object's airframe direction based on the results of the calculation.

[Item 18]

A flight program for causing a flight control server device comprised for communication over a network to function as:
control means for controlling a flight of a flying object;
flight control means for flying the flying object in a direction of travel;
sensor means for acquiring predetermined information affecting the flight;
calculation means for calculating a direction in which flight efficiency is increased based on the predetermined information, regardless of the direction of travel, from the flying object's immediately preceding state; and
flying object's airframe direction control means for controlling the flying object's airframe direction based on the result of the calculation.

[Item 19]

A flight control system comprising a flying object and a flight control server device configured to communicate with the flying object via a network,
wherein the flight control server provides the flying object with information necessary for flying in the direction of travel;
wherein the flying object controls the direction of the flying object's airframe so that the flying object faces a direction that increases flight efficiency over the flying object's immediately preceding state based on the predetermined information, regardless of the direction of travel.

[Item 20]

A flight control system comprising a flying object and a flight control server device capable of communicating with the flying object via a network,
wherein the flying object flies in a direction of travel;
wherein the flight control server provides signals to the flying object to control the direction of the flying object's airframe to face a direction that increases flight efficiency over the flying object's immediately preceding state, based on predetermined information, regardless of the direction of travel.
   <Details of Embodiments According to this Invention>

The flying object flying method according to this embodiment will be described below with reference to the drawings.

<Details of the First Embodiment>

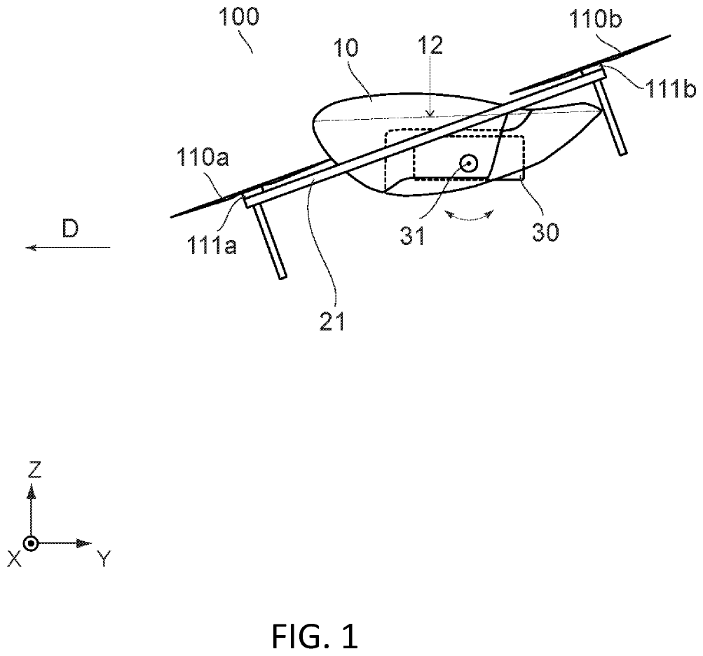

As shown in FIG. 1, the flying object 100 according to this embodiment is equipped with a flight part 20 that includes at least a body part 10, a plurality of rotary wing parts comprising a propeller 110 and a motor 111, a motor mount and frame 21 that support the rotary wing parts, and other elements for flight. It should also be equipped with energy (e.g., secondary batteries, fuel cells, fossil fuels, etc.) to operate them.

The flying object 100 shown in the figure is depicted in a simplified form to facilitate the explanation of the invention's structure, and detailed components such as the control part, for example, are not shown in the figure.

The flying object 100 is moving forward in the direction of arrow D (−Y direction) in FIG (see below for details).

In the following explanation, the terms may be used according to the following definitions. Forward/backward direction: +Y direction and −Y direction, up/down direction (or vertical direction): +Z direction and −Z direction, left/right direction (or horizontal direction): +X direction and −X direction, forward direction (front): −Y direction, reverse direction (rear): +Y direction, ascending direction (upward): +Z direction, descending direction (downward): −Z direction.

The direction of travel of the flying object is defined as shown in FIG. 0. Unless otherwise noted, the flying object's destination is in direction θ, which is the direction of arrow D.

The propeller 110 rotates under the output from the motor 111. The rotation of the propeller 110 generates propulsive force to take the flying object 100 off from its starting point, move it, and land it at its destination. The propeller 110 can rotate to the right, stop, and rotate to the left.

The propeller 110 provided by the flying object of the invention has one or more blades. Any number of blades (rotors) (e.g., 1, 2, 3, 4, or more blades) is acceptable. The shape of the blades can be any shape, such as flat, curved, kinked, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) when the blades are moved through the air. The geometry of the blade/vane can be selected as appropriate to optimize the dynamic aerodynamic characteristics of the blade/vane, such as increasing lift and thrust and reducing drag.

The propeller provided by the flying object of the invention may be, but is not limited to, fixed pitch, variable pitch, or a mixture of fixed and variable pitch.

The motor 111 produces rotation of the propeller 110; for example, the drive unit can include an electric motor or engine. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving object (e.g., size, weight) and control conditions (speed, direction of movement, etc.).

The flying object 100 determines the number of revolutions of each motor and the angle of flight according to the wind speed and direction by means of a flight controller or propo/radio. This allows the flying object to move up and down, accelerate and decelerate, and change direction.

The flying object 100 can fly autonomously according to routes and rules set in advance or during the flight, or by using a propo/radio to control the flying object.

The flying object 100 described above has the functional blocks shown in FIG. 1. The functional blocks in FIG. 1 are a minimum reference configuration. The flight controller is a so-called processing unit. The processing unit can have one or more processors, such as a programmable processor (e.g., central processing unit (CPU)). The processing unit has a memory, not shown, which is accessible. The memory stores logic, code, and/or program instructions that can be executed by the processing unit to perform one or more steps. The memory may include, for example, a separable medium such as an SD card, random access memory (RAM), or an external storage device. Data acquired from cameras and sensors may be directly transmitted to and stored in the memory. For example, still and moving image data captured by a camera or other device is recorded in the internal or external memory.

The processing unit includes a control module comprising to control the state of the rotorcraft. For example, the control module controls the propulsion mechanism (e.g., motor) of the rotorcraft to adjust the spatial arrangement, velocity, and/or acceleration of the rotorcraft having six degrees of freedom (translational motion x, y and z, and rotational motion Ox, Oy and Oz). The control module can control one or more of the states of the mountings and sensors.

The processing unit is capable of communicating with a transmission/reception unit comprised of one or more external devices (e.g., terminal, display, or other remote controller) to transmit and/or receive data. The transreceiver can use any suitable means of communication, such as wired or wireless communication. For example, the transmission/reception unit can use one or more of the following: local area network (LAN), wide area network (WAN), infrared, wireless, WiFi, point-to-point (P2P) network, telecommunication network, or cloud communication. The transmission/reception unit can transmit and/or receive one or more of the following: data acquired by sensors, processing results generated by the processing unit, predetermined control data, and user commands from a terminal or remote controller.

Sensors in this embodiment can include inertial sensors (accelerometers, gyroscopes), GPS sensors, proximity sensors (e.g., lidar), or vision/image sensors (e.g., cameras).

The plane of rotation of the propeller 110 provided by the flying object 100 in this embodiment is at a forward inclined angle toward the direction of travel when traveling. The forward inclined plane of rotation of the propeller 110 generates upward lift and thrust in the direction of travel, which propels the flying object 100 forward.

The flying object 100 has a main body part 10 that can contain the onboard processing unit, batteries, payloads, or the like. The main body part 10 is fixedly connected to the flight part 20, and the main body part 10 changes its attitude as the flight part 20 changes its attitude. The shape of the main body part 10 is optimized to increase the speed and efficiently shorten the flight time in the attitude of the flying object 100 during cruise, which is expected to be maintained for a long time during the movement of the flying object 100.

The main body part 10 should have an outer skin strong enough to withstand flight, takeoff, and landing. For example, plastic, FRP, or the like are suitable materials for the outer skin because of their rigidity and water resistance. These materials may be the same material as the frame 21 (including arms) included in the flight part 20, or they may be different materials.

The motor mount, frame 21, and main body part 10 of the flight part 20 may be comprised of connected parts, or they may be molded as a single unit using a monocoque structure or one-piece molding (e.g., the motor mount and frame 21 are molded as a single unit, or the motor mount, frame 21, and main body part 10 are molded as a single unit, etc.). By integrating the parts as one piece, the joints between each part can be made smooth, which is expected to reduce drag and improve fuel efficiency of flying object such as blended wing bodies and lifting bodies.
In the following descriptions, terms may be used interchangeably for wind blowing against a flying object according to the following definitions.
Wind speed independent of the speed at which the flying object is moving: true wind speed.
Wind direction independent of the direction of movement of the flying object: true wind direction.
Wind force combined with the speed of movement of the flying object, the direction of movement of the flying object, true wind speed, and true wind direction (wind that can be obtained by the anemometer on board the flying object): relative wind.
Wind combined with the speed at which the flying object is moving and the true wind speed (wind speed that can be obtained by the anemometer onboard the flying object): relative wind speed.

Wind direction combined with the direction of movement of the flying object and the true wind direction (wind speed that can be obtained by the anemometer onboard the flying object): relative wind direction.

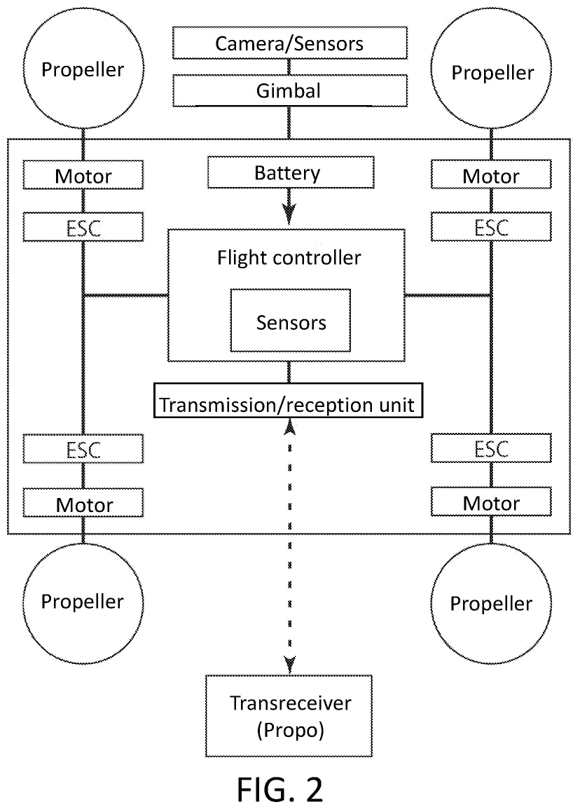

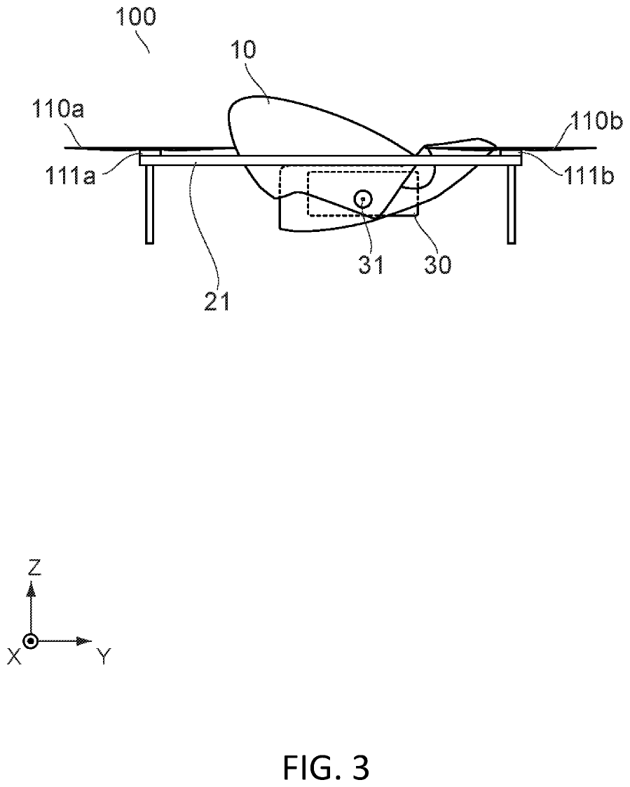

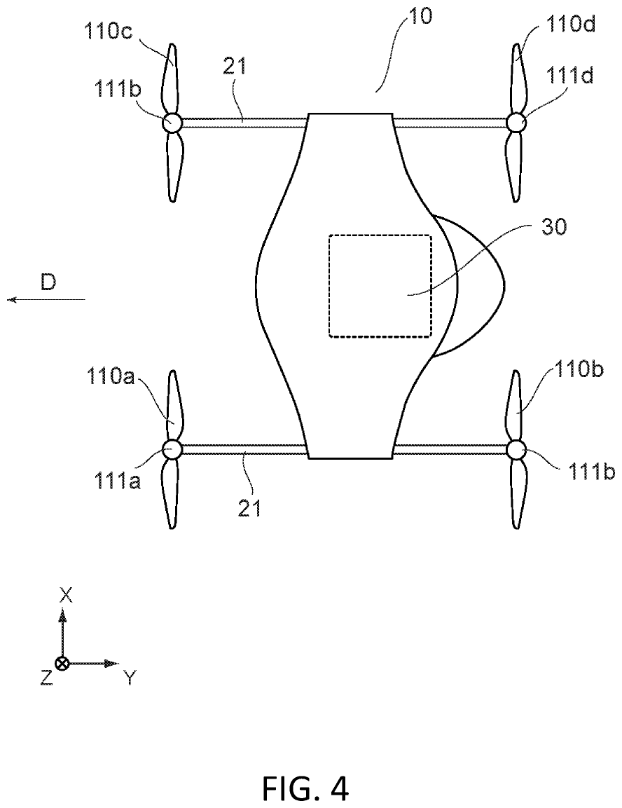

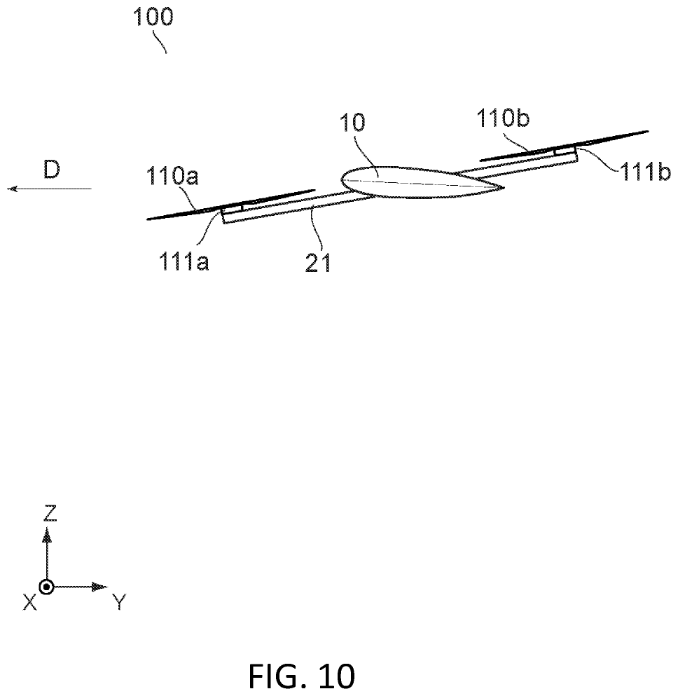

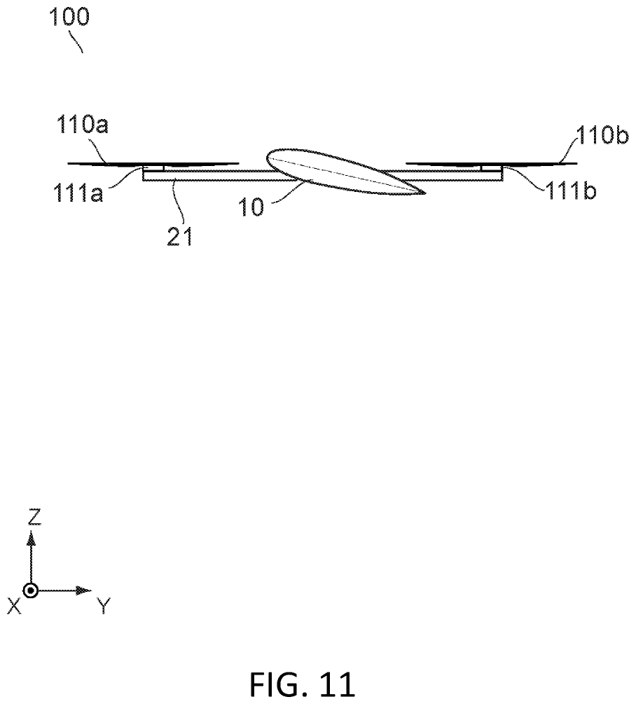

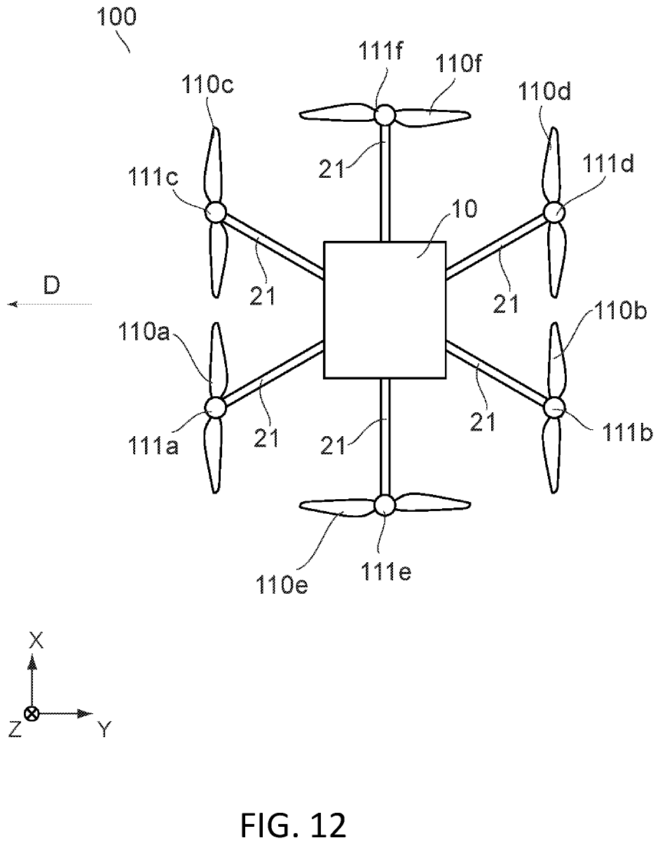

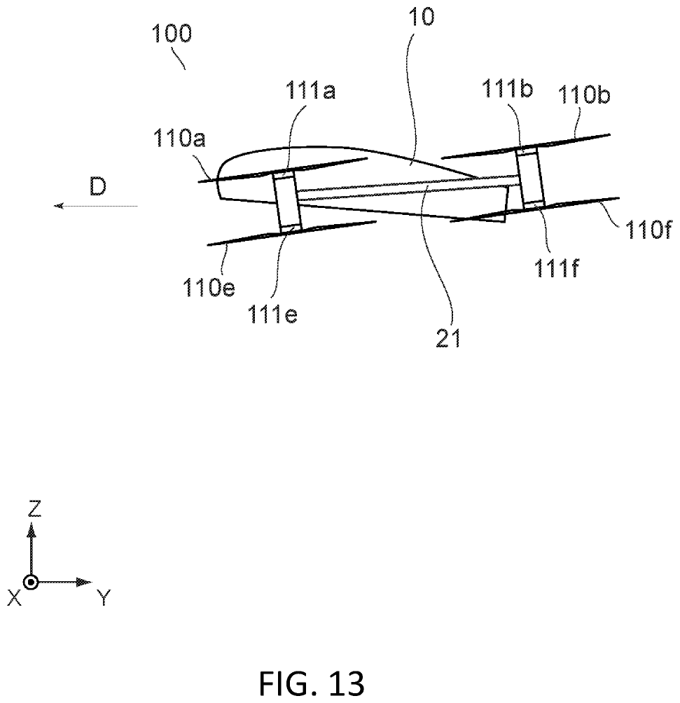

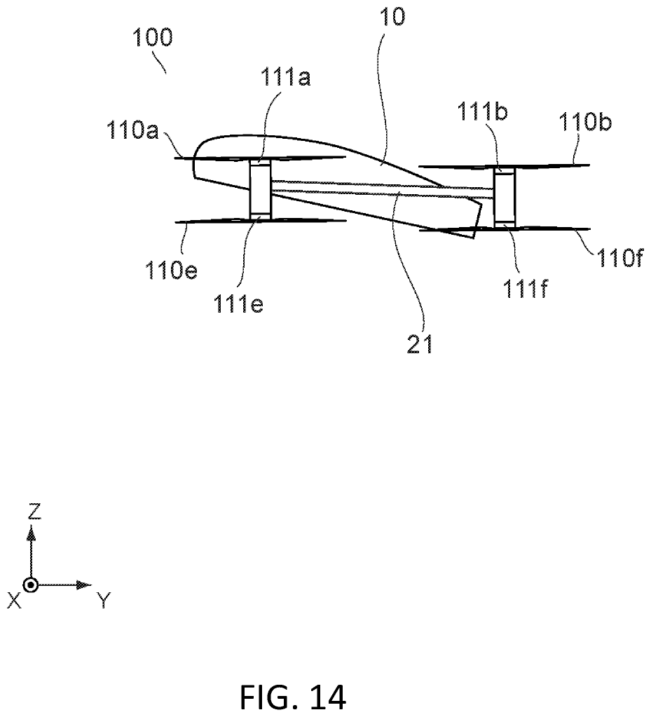

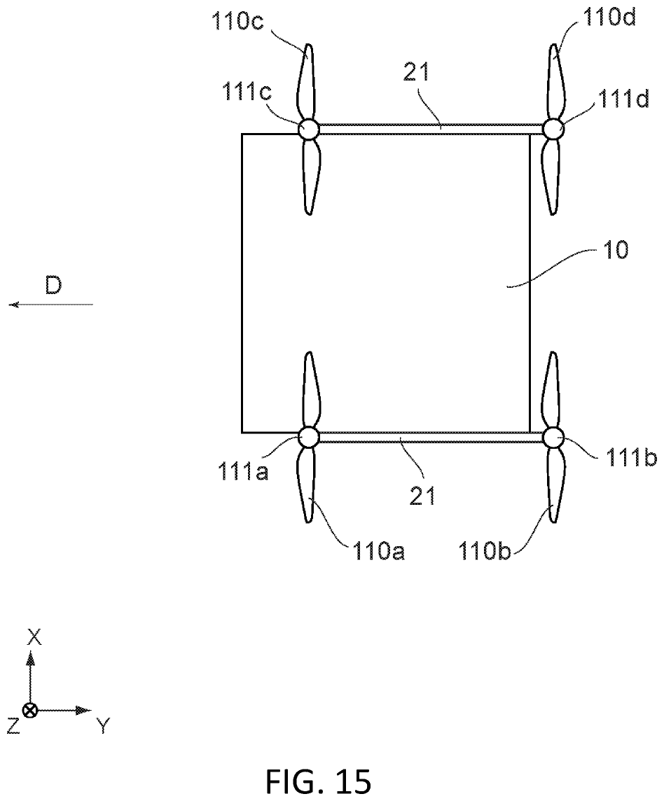

The shape of the flying object 100 is directional. For example, as shown in FIGS. 1-4, the shapes that improve the efficiency of flight when the nose of the flying object is facing the wind such as a streamlined main body part with low drag when the flying object 100 is in cruising attitude in no wind, a drop-shaped frame part with low drag, as in FIGS. 10-12, and, an airfoil-shaped main body part that produces positive lift, as shown in FIGS. 13-15, etc.

These flying objects with shapes that are effective by opposing the wind directly in the cruising attitude, in flight in no wind, the flying object will be subjected to a relative wind equal to its forward speed from the nose direction as it moves forward in the −Y direction. This makes the flying object suitable for the effect of the shape of the flying object.

However, when flying outdoors, the nose of the flying object does not always face directly into the wind because the wind blows in various directions and speeds depending on the terrain. When the flying object in motion is subjected to crosswinds, it is possible to fly without reducing flight efficiency by directing the nose of the flying object so that it is directly facing the direction of the combined forces of the relative wind force generated by the forward speed and the crosswind force.

In environments where there are no obstacles and wind direction and speed are simple, such as at sea or in grasslands, the wind often blows from one direction. Therefore, it is necessary to derive the appropriate nose direction from the wind speed in each direction and the flying object's speed of flight.

In a flying object equipped with an anemoscope and an anemometer, the nose of the aircraft is controlled to approach a positive attitude relative to the acquired relative wind direction of the flying object. For example, in no wind, the relative wind to the flying object moving in direction 0 at 10 m/s blows from direction θ, so in this case, the nose of the aircraft is directed toward direction θ and moves in direction θ. For the flying object moving in direction θ at 10 m/s, the relative wind to the flying object in an environment with a crosswind of 10 m/s blowing from direction 3 blows from direction 1.5, so the nose shall be directed in direction 1.5.

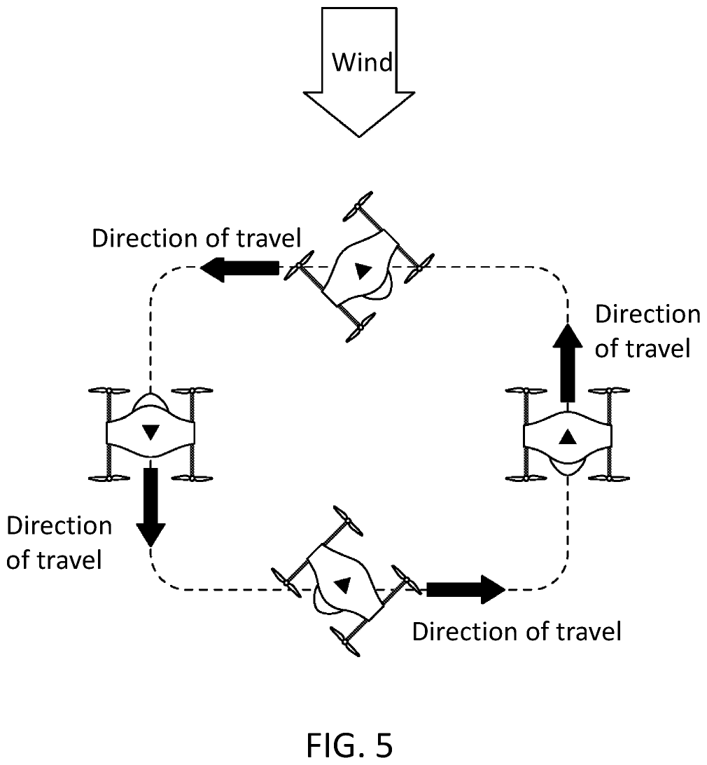

When the true wind speed and the flying object's speed of travel are balanced, the relationship between the true wind direction, the flying object's direction of travel, and the flying object's nose direction is as shown in FIG. 5.

Methods of obtaining wind direction and speed include the use of anemoscope and anemometer mounted on the flying object, derivation of wind direction and speed by calculation from the rotation speed of the motor used by the flying object for flight, and acquisition of observation data from outside sources. The appropriate method of acquisition should be selected according to the conditions of the route. For example, when flying over inland terrain with complex wind conditions, it is desirable to immediately acquire data on the location where the flying object is flying by using the equipment onboard the flying object, but when flying in offshore areas with simple wind conditions, it is possible to use wind trends derived from past accumulated data or to acquire data transmitted from the ground. If the equipment for acquiring wind direction and speed is not mounted on the flying object, the flying object will be lighter in weight.

Depending on the wind direction, flight efficiency may deteriorate if the nose of the flying object is oriented in the direction of the resultant force of the wind. For example, if a strong tailwind from direction 6 is received and the flying object's nose is pointed in directions 3 to 9, it will be in an unsuitable posture for heading in the direction θ. A tailwind mode may be provided to prevent the aircraft from continuing to fly in an unsuitable attitude.

The tailwind mode control, for example, turns the nose of the flying object in direction θ under the following conditions. (1) When the nose of the flying object turns to direction 6 from direction 4 or 8. (2) When the anemoscope on the flying object indicates directions 5˜7.

We have discussed flying objects designed to improve flight efficiency when moving forward primarily in the frontal (−Y) direction of the flying object. However, in flying objects that are designed to improve flight efficiency in different directions, the nose of the aircraft is not directed in the direction of the combined wind force, but is controlled to direct other parts of the aircraft that can improve flight efficiency.

Flight efficiency can also be improved in surveillance, security, and other operations in which the flying object stays in one place (hovering) by turning the nose of the flying object squarely in the direction of the relative winds. In flying objects with the least drag when the nose of the flying object is facing directly into the wind, the nose of the flying object should be controlled to point in the direction of the relative wind. Compared to hovering against a wind from a direction other than the nose direction, the flying object is less affected by crosswinds, etc., and the force consumed to face the wind is reduced, thereby improving flight efficiency.

<Details of the Second Embodiment>

In the details of the second embodiment of this invention, the components that overlap with those of the first embodiment operate in the same manner, so they will not be described again.

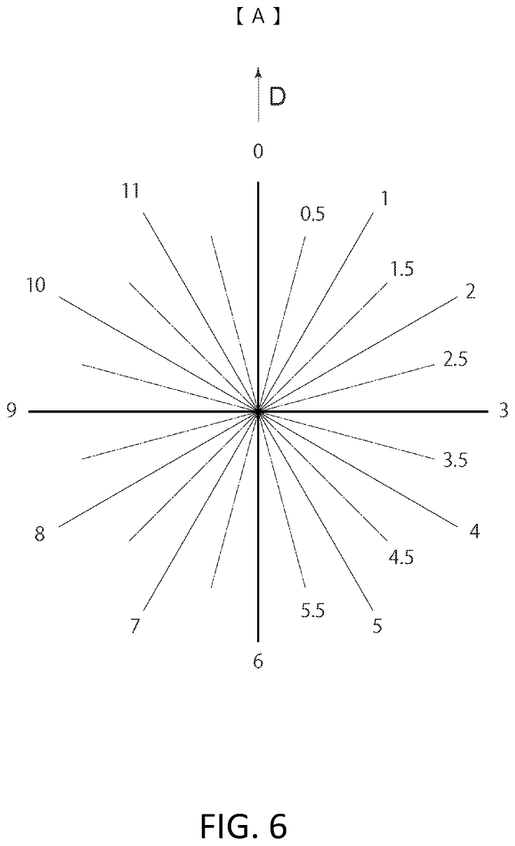

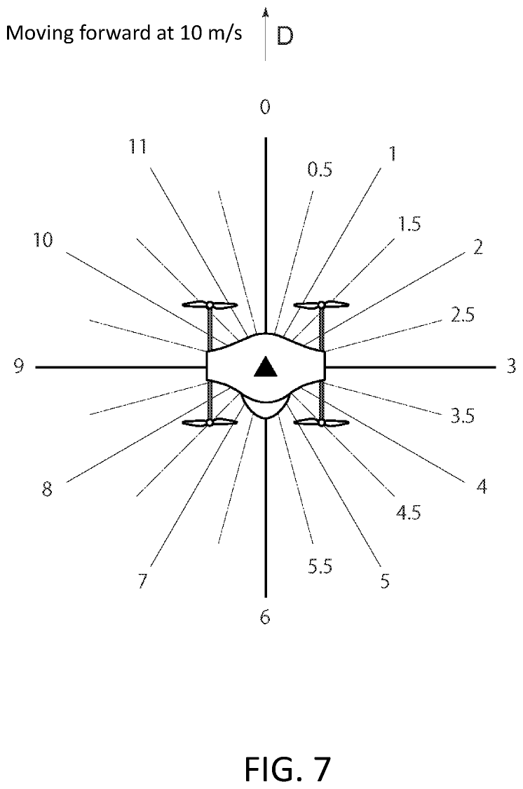

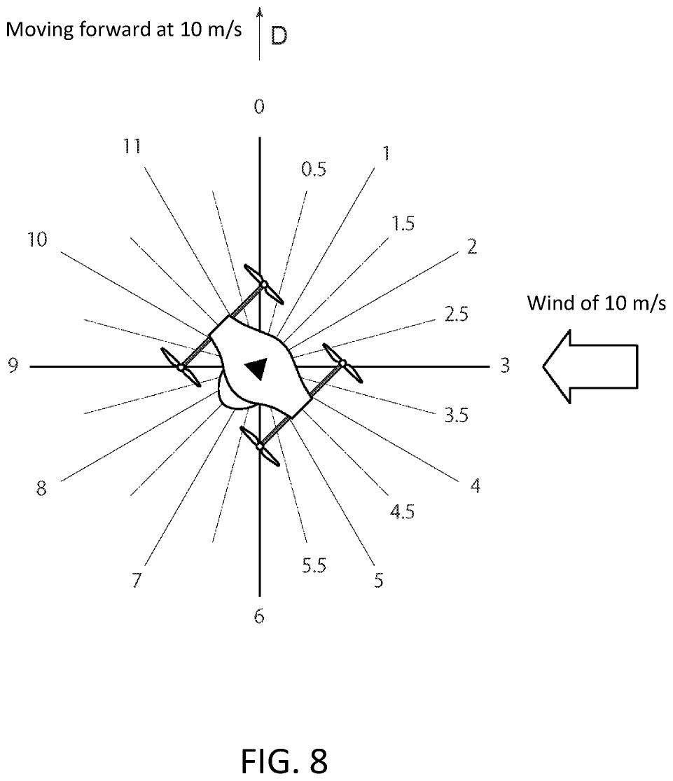

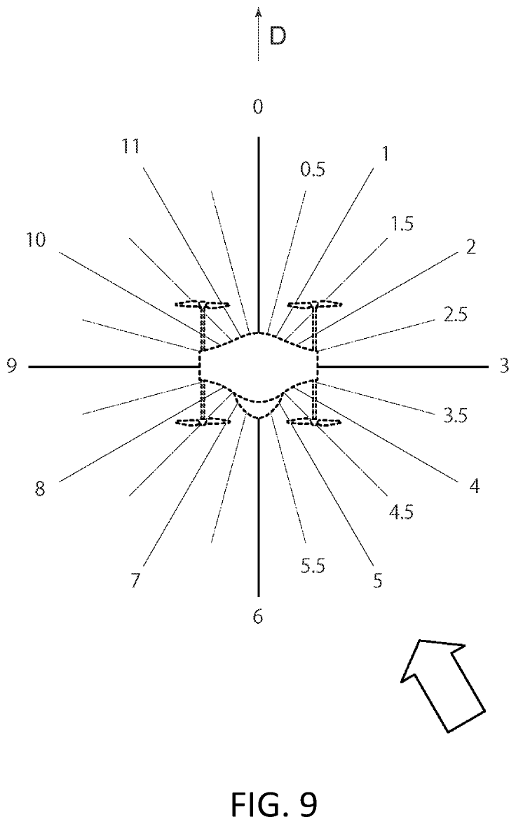

As shown in FIGS. 6 through 9, the flying object may be shaped to control yaw rotation in order to keep a particular plane (e.g., nose) squarely on the windward side.

When the nose of a flying object is pointed upwind, the area behind the center of gravity of the flying object should be wider than the area in front of the center of gravity. As a result, when the flying object receives wind from a direction other than the nose, the rear of the flying object, which receives wind over a larger area, is pushed by the wind to the leeward side, and the nose, which is in front of the flying object, faces the windward side.

The air resistance behind the flying object may be increased or decreased in order to switch the effect between when control of the flying object's orientation in response to relative wind direction is necessary and when it is unnecessary. For example, by moving the plate-shaped rotation control part from an attitude parallel to the XY plane to an angle that is parallel to the ZY plane, the force of the flying object turning its nose upwind becomes stronger. Thus, by changing the angle of the rotation control part, it is possible to change the strength of the control in the yaw direction.

The strength of yaw control can be adjusted by increasing or decreasing the area in the lateral view, since the vertical area on the side surface of the flying object has a large effect. For example, the rotation control part can increase or decrease the area in the lateral view by adjusting the angle of the plate shape, expanding or contracting the bag-shaped parts, or stretching or contracting the frame.

It is possible to comprise more than one flying object in each of the embodiments. It is desirable to comprise a suitable configuration in accordance with the cost in manufacturing the flying object and the environment and characteristics of the location where the flying object will be operated.

The above mentioned embodiments are merely examples to facilitate understanding of the invention and are not intended to be construed as limiting the invention. It goes without saying that the invention may be changed and improved without departing from its purpose, and that the invention includes its equivalents.

### DESCRIPTION OF REFERENCE NUMERALS

10 Main body part
11 Driving blade
12 Wing chord line
13 Camber line
20 Flight part
21 Frame
30 Mounting part
31 Connecting part
100 Flying object
110a-110h Propeller
111a-111h Motor

1. A method for controlling a flying object, wherein the direction of an airframe of the flying object is controlled so that it faces in a direction that increases the efficiency of flight over the flying object's immediately preceding state, based on predetermined information.

2. The method of controlling a flying object as described in claim 1,
wherein the flying object is flying in a direction of travel; and
the flying object's airframe direction is controlled regardless of the direction of travel.

3. The method for controlling a flying object as described in claim 1,
wherein the direction that improves flight efficiency is increased is a predetermined set direction with respect to the flying object's airframe; and
wherein the method controls the flying object's airframe direction to be the same as the set direction.

4. The method of controlling a flying object according to claim 3,
wherein the set direction is a direction in which flight efficiency is maximized when the flying object is subjected to wind from a predetermined direction.

5. The method of controlling a flying object according to claim 4,
wherein the set direction is the direction in which flight efficiency is maximized when the front of the flying object's airframe is facing the wind.

6. The method of controlling a flying object according to claim 1,
wherein the flying object's airframe direction is controlled based on information on the wind affecting the flying object.

7. The method of controlling a flying object according to claim 6, further comprising:
acquiring a relative wind direction relative to the flying object; and
controlling the flying object's airframe direction based on the acquired relative wind direction.

8. The method of controlling a flying object according to claim 6, further comprising:
acquiring a relative wind direction and a relative wind speed relative to the flying object; and
controlling the flying object's airframe direction based on the acquired relative wind speed and relative wind direction.

9. The method of controlling a flying object according to claim 5,
wherein the wind information affecting the flying object is information calculated based on both the speed of the flying object in the direction of travel and at least one of the wind direction or wind speed around the flying object.

10. The method of controlling a flying object according to claim 5,
wherein the flying object comprises an anemoscope; and
wherein the flying object's airframe direction is controlled according to the wind direction obtained from the anemoscope.

11. The method for controlling a flying object according to claim 5, further comprises:
controlling the flying object's airframe direction based on the wind information that affects the flying object by referencing an external wind direction information database.

12. The method of controlling a flying object according to claim 1,
wherein the flying object controls the direction of the flying object's airframe so that the resistance of the wind against the flying object is reduced when the flying object is hovering.

13. The method of controlling a flying object according to claim 1,
wherein the flying object controls the direction of the airframe so that the wind resistance against the airframe is reduced when the flying object is ascending or descending.

14.-18. (canceled)

19. A flight control system comprising a flying object and a flight control server device configured to communicate with the flying object via a network,
wherein the flight control server provides the flying object with information necessary for flying in the direction of travel;
wherein the flying object controls the direction of the flying object's airframe so that the flying object faces a direction that increases flight efficiency over the flying object's immediately preceding state based on the predetermined information, regardless of the direction of travel.

20. A flight control system comprising a flying object and a flight control server device capable of communicating with the flying object via a network,
wherein the flying object flies in a direction of travel;
wherein the flight control server provides signals to the flying object to control the direction of the flying object's airframe to face a direction that increases flight efficiency over the flying object's immediately preceding state, based on predetermined information, regardless of the direction of travel.

21. The method for controlling a flying object as described in claim 2,
wherein the direction that improves flight efficiency is increased is a predetermined set direction with respect to the flying object's airframe; and
wherein the method controls the flying object's airframe direction to be the same as the set direction.

22. The method of controlling a flying object according to claim 21,
wherein the set direction is a direction in which flight efficiency is maximized when the flying object is subjected to wind from a predetermined direction.

23. The method of controlling a flying object according to claim 22,
wherein the set direction is the direction in which flight efficiency is maximized when the front of the flying object's airframe is facing the wind.
